(19) United States
(12) Patent Application Publication
(10) Pub. No.: US 2006/0008777 A1
(43) Pub. Date: Jan. 12, 2006

(54) System and mehtod for making sequentially layered dental restoration

(76) Inventors: David Sherwin Peterson, Basin, WY (US); Timothy Miguel Willardson, Payson, UT (US)

Correspondence Address: John M. Guynn;WORKMAN NYDEGGER, 1000 Eagle Gate Tower, 60 East South Temple, Salt Lake City, UT, 84111, US

(21) Appl. No.: 11/175,921

(22) Filed: Jul. 6, 2005

Related U.S. Application Data
(60) Provisional application No. 60/586,572, filed on Jul. 8, 2004.

(51) Int. Cl. A61C 5/10; A61C 9/00

(52) U.S. Cl. 433/223; 433/40

(57) ABSTRACT

A method for preparing a layered dental restoration includes the following: (a) causing a virtual impression a dentition to be created; (b) causing a virtual restoration to be generated, wherein the virtual restoration includes sequential virtual layers; and (c) fabricating a dental restoration from the virtual restoration by sequentially building individual layers of materials to a shape substantially similar with the shape of the virtual restoration exterior surface, wherein each individual layer corresponds to a virtual layer. The materials forming each layer can be a composite, porcelain, ceramic, or other like material. Fabricating a dental restoration can be performed by a restorative matrix system. The system includes a base member having an aperture defined by an aperture wall, wherein the aperture is configured to fit tightly a tooth. The base member also has a seating index. Additionally, the system includes at least one mold that fits the tooth so as to apply a layer of curable composite material thereto. Moreover, the at least one mold has a portion configured to releasable seat into the seating index of the base member.

### CROSS-REFERENCE TO RELATED APPLICATIONS

The present application claims the benefit of earlier filed U.S. Provisional Patent Application Ser. No. 60/586,572, entitled “STERIOLITHOGRAPHIC GENERATED RESTORATIVE MATRIX SYSTEM (“SGRMS”), filed on Jul. 8, 2004, with David Sherwin Peterson, DDS, and Timothy Miquel Willardson as inventors, the disclosure of which is incorporated herein by reference.

### BACKGROUND OF THE INVENTION

1. The Field of the Invention

The present invention relates to systems and methods for making dental restorations from computer generated images. The invention also relates to the manufacture of sequentially layered dental restorations inside or outside of a patient's mouth.

2. The Related Technology

Many people suffer from inadequate dentitions, where the structure of individual teeth may not be properly formed or the teeth are incorrectly aligned. Additionally, many current dental techniques are inadequate and not individualized. Thus, there continues to be a need for new avenues for dentition reshaping and aligning.

Therefore, it would be beneficial to have a dental restorative process that uses a patient's existing teeth as a template for preparing a dental restoration. Also, it would be advantageous to build a dental restoration layer-by-layer so that the materials of individual layers can be properly selected in order to provide the restoration with favorable characteristics.

### BRIEF SUMMARY OF THE INVENTION

Generally, the present invention includes a method for preparing a layered dental restoration. Such a dental restoration can be designed after a virtual impression of a tooth or teeth is obtained. The virtual impression is used for obtaining a virtual restoration that includes sequential virtual layers extending from the virtual impression to a virtual restoration exterior surface. The virtual restoration is used as a template for fabricating a dental restoration by sequentially building restorative layers until the dental restoration has substantially the shape of the virtual restoration exterior surface. Also, each restorative layer corresponds with a virtual layer, and the materials forming each restorative layer can be a composite, porcelain, ceramic, or other like material.

In one embodiment, the present invention includes a method of fabricating a dental restoration inside of a patient's mouth. The dental restoration can be formed after a base member is placed onto at least one tooth so as to move gingiva away from the tooth or teeth. A restorative mold is then placed over the tooth until it seats in a seating index on the base member, wherein the mold includes a curable material within a mold cavity. Alternatively, the curable material could be placed onto the tooth before the mold. A layer of the dental restoration is formed by curing the curable material in the restorative mold. The restorative mold is then removed so as to leave at least one restorative layer on the tooth or teeth.

In one embodiment, the present invention includes a method of fabricating a layered dental restoration outside of the patient's mouth. In such a method, a virtual restoration is obtained and used as a template for the layered dental restoration. The dental restoration is formed by depositing sequential restorative layers from an interior layer substantially through an external layer, wherein the external layer is substantially shaped as the virtual restoration. Sequentially depositing the restorative layers forms the layered dental restoration, wherein the sequential restorative layers are shaped substantially as the sequential virtual layers.

In one embodiment, the present invention includes a restorative system comprised of a base member that couples with at least one restorative mold.

These and other embodiments and features of the present invention will become more fully apparent from the following description and appended claims, or may be learned by the practice of the invention as set forth hereinafter.

### BRIEF DESCRIPTION OF THE DRAWINGS

Embodiments of the invention will be described and explained through the use of the accompanying drawings in which:

FIG. 1 is a flow diagram illustrating an embodiment of a method for generating a virtual dental restoration;

FIG. 2A is a cross-sectional side view illustrating an embodiment of a dental restoration comprised of a plurality of sequential layers;

FIG. 2B is a side view illustrating the external surface of the completed dental restoration of FIG. 2A;

FIG. 3A is a cross-sectional top view illustrating an embodiment of a hemostatic matrix;

FIG. 3B is a cross-sectional side view illustrating the hemostatic matrix of FIG. 3A;

FIG. 3C is a side view illustrating the hemostatic matrix of FIG. 3A;

FIG. 3D is a cut-away perspective view illustrating the hemostatic matrix of FIG. 3A;

FIGS. 4A-C are bisected cross-sectional side views illustrating different embodiments of a restoration system;

FIG. 5A is a perspective view illustrating an embodiment of a multi-tooth restoration system; and

FIG. 5B is a perspective view illustrating a portion of the multi-tooth restoration system of FIG. 5A.

### DETAILED DESCRIPTION OF THE PREFERRED EMBODIMENTS

Generally, the invention includes systems and processes for making dental restorations. The dental restorations can provide an idealized single tooth, multiple teeth, and/or complete dentition, wherein natural and/or optimal spacing between adjacent teeth can be obtained. The dental restorations are prepared from as few as one layer through multiple layers of materials, wherein the layers can have different colors, translucency, strength, hardness, porosity, and the like to mimic the appearance and function of natural teeth. The dental restorations can be prepared from composites, porcelains, ceramics, or other like materials.

In one embodiment, the dental restoration is made within a patient's mouth. As such, a series of restorative layers are prepared from a series of molds that allow the restoration to be built outward from the patients' tooth, teeth, or implant. Alternatively, the dental restoration may be prepared outside the patient's mouth by sequentially depositing a series of layers that harden so as to form a layered dental restoration that can be applied and affixed to a patient's tooth, teeth or implant.

A candidate for receiving the dental restoration in accordance with the present invention can vary through a broad range of dental needs, such as a patient that only needs a single tooth or their entire dentition restored. Also, the dental restoration can be used to fix tooth defects, such as chips, cracks, and the like, or to correct a patient's jaw alignment to NM or CR positions. Additional information for pre-restoration work-ups can be reviewed in the incorporated reference.

I. Virtual Dental Restorations

In order to prepare the foregoing dental restorations, one embodiment of the present invention includes the generation of virtual dental restorations. As such, the virtual restorations are used as the blueprints for the actual dental restorations. While one embodiment of generating virtual restorations is described herein, it should be recognized that various modifications can be made within the scope of the invention. Also, supplemental information can be obtained in the incorporated reference.

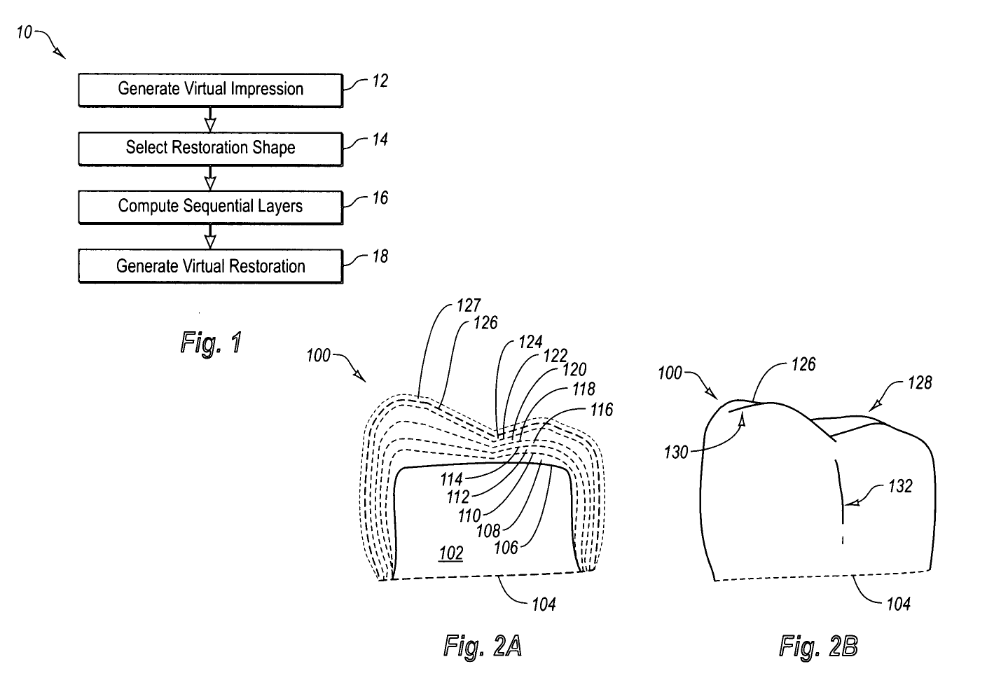

FIG. 1 is a flow diagram illustrating one embodiment of a process 10 for preparing virtual dental restorations to be used in making the actual dental restorations. Such a process 10 includes generating a virtual impression of the patient's tooth, multiple teeth, and/or dentition (Block 12), which may include an implant. When the patient's entire natural dentition has been removed, implants can serve as “teeth” for obtaining the virtual impression. The virtual impression can be prepared by techniques well known in the dental arts.

Briefly, a negative physical impression can be made by using any suitable moldable material, such as an alginate, poly(vinyl siloxane), or the like. A positive physical cast, such as a stone cast, of the dental impression can then be prepared from the negative impression. Either the negative or positive physical impressions can be used with various scanning techniques, such as computed tomography (“CT”), to obtain or generate a virtual impression that can be manipulated on a computer system. Alternatively, direct scanning or digital photographs of the patient's dentition can be obtained for use in generating the virtual impression. The virtual images can be manipulated on a computer system using various computer-aided drawing (“CAD”) programs, wherein various dimensions or other physical characteristics can be input and/or modulated.

Additionally, the shape of the virtual and/or physical dental restoration can be selected (Block 14). The shape can be selected by various methods such as the following: (a) selecting the shape from a shape databank; (b) selecting the shape based on visual appearance and/or aesthetics; (c) selecting the shape based on CR and NM dental standards; (d) selecting the shape based on processing data relating to the virtual image through an algorithm; (e) selecting the shape based on surrounding teeth in the dentition; (f) selecting the shape based on building a restoration from the virtual impression; (g) combinations of the foregoing; and (h) other shape-selection factors. In any event, a shape for the virtual restoration is selected to be a template for preparing the physical restoration.

The virtual impression is computed with a CAD-like program to generate sequential build layers that start with the virtual impression and result in the selected restoration shape (Block 16). That is, the virtual impression is processed through a computer program that generates a sequence of build layers to form the shape of the virtual restoration. As such, the virtual impression and/or the selected restoration shape can be processed through various algorithms so that sequentially larger layers are generated, wherein the virtual impression is the smallest layer and the selected shape is the largest or most exterior layer. The sequential layers can be generated by the following: (a) calculating a thickness of each virtual layer; (b) calculating at least one of an internal surface area or external surface area of each virtual layer, wherein the internal surface area of each layer is larger then the external surface area of the preceding layer; and (c) processing the virtual impression and selected dental restoration shape through an algorithm to generate the sequential virtual layers.

Accordingly, after the sequential layers have been generated, the computer can be used to generate the virtual restoration (Block 18). As such, the virtual restoration can be generated by computing the virtual impression, sequential layers, and selected shape, which together form the virtual restoration. Additionally, various other computing techniques can be performed to impart certain features or characteristics to the virtual restoration. Some of these physical features include modifying the shape, size, position, spacing, contours, and the like for individual teeth up to an entire dentition. Also, the virtual restoration can be computed to select visual characteristics such as color, translucency, opacity, and the like as well as physical characteristics such as strength, hardness, porosity, and the like. These features and characteristics can be used to select the physical compositions of a composite, porcelain, and/or other like material for each of the sequential layers for use in preparing a physical restoration.

Also, the computer program can be configured to select the composition of the layered materials used to fabricate the physical dental restoration. As such, the composition of the individual layers can be selected so that when combined, the physical dental restoration provides the desired characteristics. This can include selecting the following: (a) type of curable resin; (b) amount of resin; (c) type of polymerization inducer; (d) amount of polymerization inducer (e) type of filler particles; (f) size of filler particles; (g) amount of filler particles; (h) transparency, translucency, or opacity; (i) hardness; (j) color; and (k) other similar dental restoration criteria.

In another embodiment, the composition of materials for ink-jet printing a three-dimensional restoration can be determined. This can include selecting the following: (a) type of ink-jettable material (i.e., wetting agent, adhesive material, porcelain powder; colored slip, etc.); (b) type of material for ink-jet printing; (c) amount of material; (c) type of powdered material for use with ink-jettable material, if any; (d) amount of powdered material (e) type of filler particles; (f) size of filler particles; (g) amount of filler particles; (h) transparency, translucency, or opacity; (i) hardness; (j) color; and (k) other similar dental restoration criteria. Alternatively, the composition of materials usable with other types of rapid-prototyping and/or rapid-manufacturing processes can be determined in order to prepare a dental restoration in accordance with the present invention.

FIGS. 2A-B illustrate an embodiment of a virtual restoration 100 generated using a CAD-like program such as a virtual restoration to be used as the blueprint for preparing a physical restoration. Alternatively, the figures can represent the physical restoration prepared from the virtual restoration 100.

For example, the computer program uses the tooth/template 102 as the basis or starting point for preparing the virtual restoration 100 above the gingival line 104 and having an external/anatomical surface 126. As such, the tooth can be in its natural condition or prepared by trimming, milling, or other dental techniques. A prepared tooth can have sides that are substantially vertical to enable the molds or matrices of the present invention to fit thereon, or wherein the top is the same or smaller then the bottom. Also, the tooth/template 102 can be an implant, wherein an implant is considered to be a tooth for the purposes of the present invention.

As shown, the tooth/template surface 106 is enclosed within a first virtual/restoration layer 108 that has a first layer surface 110. The first layer surface 110 is then enclosed within a second virtual/restoration layer 112 having a second layer surface 114. The second layer surface 114 is then enclosed within a third virtual/restoration layer 116 having a third layer surface 118. The third layer surface 118 is then enclosed within a fourth virtual/restoration layer 120 having a fourth surface 122. The fourth layer surface 122 is then covered with a fifth virtual/restoration layer 124 having a fifth layer surface 126. Additionally, the fifth virtual/restoration layer 124 can be considered to be an n^{th} virtual/restoration layer 124 having an n^{th} layer surface 126 because any number of layers can be made (i.e., from 1 to n layers).

While any number of layers can be used, the fifth and final layer 124 is depicted to have an anatomical surface 126. Additionally, the anatomical surface 126 can be configured to include occlusal surface features 128, external surface features 130, buccal surface features 132, or any other tooth-surface features to give character and definition to the dental restoration.

II. Restorative Matrices

As briefly described above, the dental restorations can be prepared within the patient's mouth using a restorative matrix system that includes a base component and a series of molds or matrices. As used in the dental arts, a mold for use with a dental composition is sometimes referred to as a matrix. In any event, such a process uses molds with mold cavities that provide physical restorative layers that can be substantially similar to the foregoing virtual layers. The base component is used to orient and/or position the molds relative to the exposed tooth or dentition needing the restoration. The base component can be oriented onto the tooth or teeth using guide buttons. The molds are oriented on the teeth by coupling with the base component before a curable composition within the mold cavity is cured and hardened. Additionally, the base component can be configured to push the gingiva away from the base of the tooth's crown and thus prevent any bleeding from interfering with the build-up procedure. Further, the base component and molds can be constructed with walls between the individual tooth structures so that the dental restorations are created to maintain natural and/or optimal spacing.

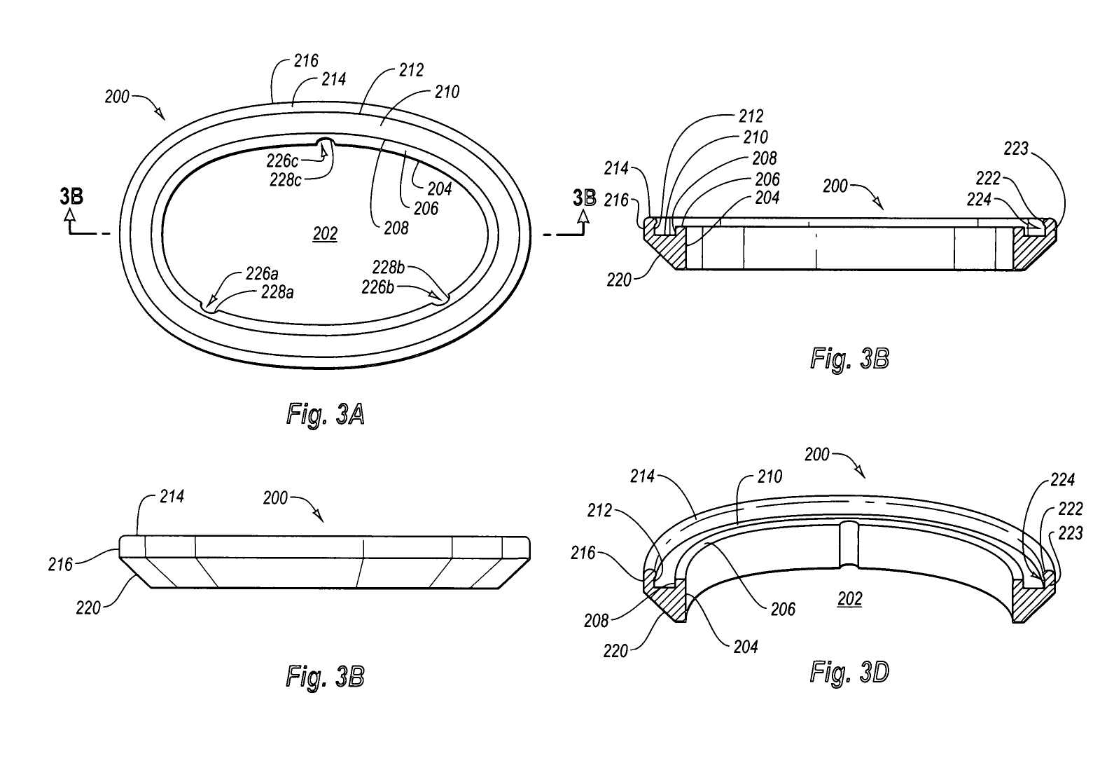

FIGS. 3A-3D are various views illustrating an embodiment of a hemostatic restorative matrix (“HRM”) 200, which is a base component configured to prevent blood from interfering with the restorative process. The various shapes, dimensions, and proportions should not be strictly construed, as the figures are not necessarily drawn to scale. As such, FIGS. 3A-D provide the general features of an HRM 200, and many variations can be made thereto within the scope of the present invention.

The HRM 200 is characterized by including a tooth aperture 202 defined by an aperture surface 204 having the shape, dimensions, and physical composition to fit over a tooth or dentition and/or around the base of the tooth or dentition. An external surface 216 is opposite of the aperture surface 204, and defines the shape of the HRM 200. The distance between the external surface 216 and aperture surface 204 can be constant or varied so that it can be placed between adjacent teeth and/or provide lingual, distal, or other dental spacing to accommodate the features of a mold.

The HRM 200 can include a gingival surface 220 at its lower portion that is configured to contact the patient's gingiva. More particularly, the gingival surface 220 can be shaped and configured to push or otherwise move the gingival tissue away from the base of the crown. This allows for the HRM 200 to be situated below the gingival line so that at least the bottom portion of the dental restoration is at, or covered by, the gingiva when the build-up procedure is complete.

Additionally, the HRM 200 can include a guide 206 having a guide surface 208, and seat base 210. The guide 206 and guide surface 208 can be used to position a mold with the tooth, wherein the seat base 210 can provide the base for the mold to fit into when applied over a tooth or dentition. These features can circumferentially extend around the entire HRM 200, or be located at discrete and/or incremental positions. While the seat index components are shown to be proximate to the tooth aperture 202, it could be located at a distal position or even along the outer edge.

The HRM 200 can also include a seating index (“SI”) 223 defined by an inner surface 212 and outer surface 216. The SI 223 can further include features such as a clasp 222 and retaining groove 224, which together can hold the mold in place after it has been properly positioned with the seating index. Additionally, a retaining groove 224 can be located on the outer surface 216. Thus, after a mold has been guided onto a tooth with the SI 223, it can be retained in place with the clasp 222 and/or retaining groove 224. The SI 223 can circumferentially extend around the entire HRM 200, or be located at discrete and/or incremental positions. Also, it is possible for a clasp 222 to protrude from the perimeter of the HRM 200.

Optionally, the HRM 200 can include guide button notches 226a-c defined by notch surfaces 228a-c formed into the aperture surface 204. The tooth can be equipped with guide buttons affixed thereto, which fit into the guide button notches 226a-c when the HRM 200 is properly positioned. Alternatively, the tooth can be configured with notches to receive guide buttons protruding from the HRM, where such modifications are self-evident. While three guide button notches 226a-c are depicted, any number can be used; however, it can be beneficial to have at least three so that triangulation positioning techniques can be employed.

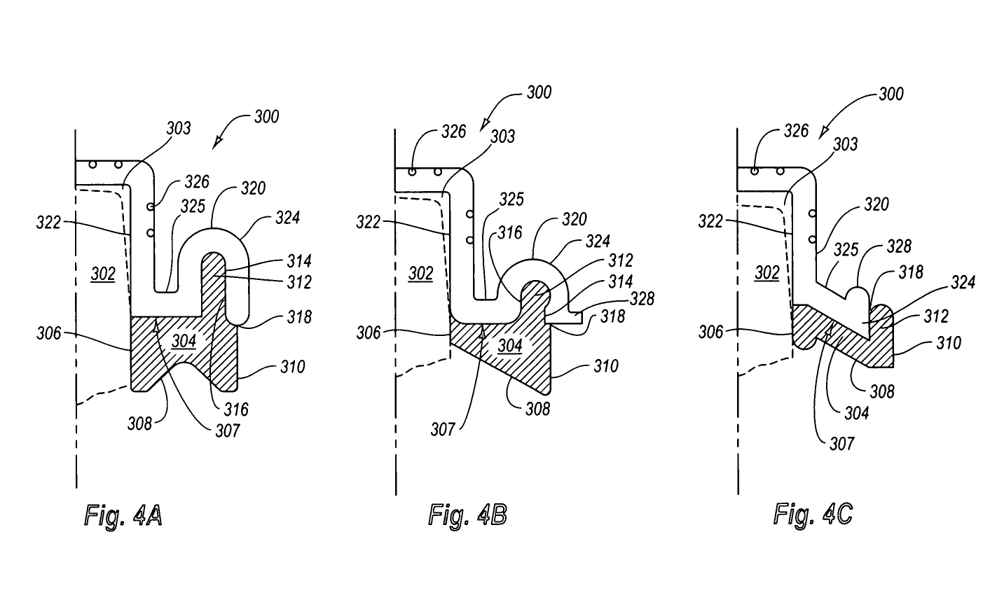

FIGS. 4A-4C are bisected cross-sectional side views illustrate embodiments of restorative matrix systems 300. As such, the drawing depicted on the right side of each figure can be mirrored on the left side of the bisecting vertical line for a full cross-sectional view. Each restorative matrix system 300 is configured to fit over a tooth 302 (e.g., crown, prepared crown, partial restoration, and the like) so that a space 303 is provided for being filled with a curable composite material. Generally, the restorative matrix system 300 includes a HRM 304 and a sequential restorative mold or matrix (“SRM”) 320 that fits over at least one tooth needing to be restored. While various embodiments of restorative matrix systems 300 are depicted, other configurations can be made within the scope of the invention. Thus, the illustrated embodiments are merely some examples of how a restorative matrix system 300 can be used in preparing a dental restoration on a tooth 302.

The HRM 304 can include a tooth-side surface 306 that can be formed into various shapes and configurations. The tooth-side surface 306 is positioned adjacent to a tooth 302 or dentition so that the curable composition does not leak down onto the gingiva, and to prevent blood from entering into any interstitial space within the restorative matrix system 300. Also, the tooth-side surface 306 can include a retraction cord (not shown).

Additionally, the HRM 304 can include a gingival surface 308 configured to contact and/or move the gingival tissue from the base of the tooth 302 (crown). More particularly, when the HRM 304 is applied to the tooth 302 or dentition, the gingival surface of the gums can be pushed down and/or away from the tooth 302 so that the restoration can extend to or below the gingival line. Also, the distal surface 310, which can be adjacent with the gingival surface 308 and opposite of the tooth-side surface 306, can also aid in keeping the gingiva or blood from interfering.

The HRM 304 can also include a SI 312 for guiding the SRM 320, as described above. Briefly, the SI 312 can have features that cooperate with features on the SRM 320 to form a removably-interlocking junction 318. Usually, the SRM 320 includes an interlocking portion 324 that includes features for forming the interlocking junction 318 with the SI 312. For example, this can be accomplished with the SRM 320 and HRM 304 forming the junction 318 at an external contact surface 314 and/or an internal contact surface 316. Optionally, various cooperative recesses, protrusions, tongue-and-grooves, and the like (not shown) can be included at any position along the external contact surface 314 and/or internal contact surface 316. As before, the SI 312 and corresponding interlocking portion 324 can circumferentially extend around the entire HRM 304 and SRM 320, or be located at discrete and/or incremental positions. Alternatively, the SI 312 and corresponding interlocking portion 324 can be positioned on the exterior surfaces 310.

Also, the SRM 320 can include a seating portion 325 that is configured to cooperate with a seat 307 and/or SI 312 of the HRM 304 when being coupled together. The seating portion 325 can couple with the seat 307 when the SRM 320 is fit onto the HRM 304. As before, the seating portion 325 and corresponding seat 307 can circumferentially extend around the entire HRM 304 and SRM 320, or be located at discrete and/or incremental positions.

The SRM 320 includes a mold portion 322 that is configured for providing a cavity 303 between the SRM 320 and the tooth and/or partial restoration. In use, the restorative matrix system 300 is configured to have a cavity 303 between the restorative SRM 320 and the tooth 302, which can be a partially restored tooth having layers of composite materials already cured thereon. More particularly, the cavity 303 can be of any shape, size, and/or configuration that can impart a curable composition to the tooth. In some instances, a small cavity 303 can be beneficial, where a larger cavity 303 can be advantageous for other applications. Also, the cavity 303 can vary in thickness depending on the location relative to the SRM 320 and/or tooth 302 as well as on the number of layers that have already been deposited.

Additionally, the mold portion 322 of the SRM 320 can include air vents 326. The air vents 326 can aid in allowing air to escape from within the cavity 303 when the SRM 320 is being applied over the tooth 302 and coupled with the HRM 304. That is, the air vents 326 can keep air pockets from being trapped within the restoration. Also, the air vents 326 can provide a conduit for excess composite material.

Optionally, the SRM 320 can include a tab 328 configured to release the mold 320 from the HRM 304. The tab 328 is optional because the SRM 320 can be removed without it. However, the use of a tab 328 or other leverage providing member can make separating the SRM 320 from the HRM 304 easier. Alternatively, various leverage proving tools can be used to pry the SRM 320 off from the HRM 304.

In one embodiment, the shapes of the SI 312, interlocking portion 324, seat 307, and seating portion 325 can be inverted with respect to the illustration of the SRM 320 and HRM 304 in FIGS. 4A-4C. That is, the corresponding features of the SRM 320 and HRM 304 can be switched so that the seat 307 fits into seating portion 325 and the interlocking portion 324 fits into the SI 312. Accordingly, various other modifications to the shapes and configuration of the restorative matrix system 300 can be made within the scope of the present invention, and features illustrated herein should not be construed in a limiting manner.

Additionally, two other shapes of coupling features can be used, wherein a female part incorporated into the HRM can receive a male part of the SI incorporated in the SRM, or vice versa. More particularly, the SI can be referred to as O-ring SI (“OSI”) and a compression SI (“CSI”). The OSI is a protruding shaped SI that extends circumferentially around the prepared tooth at the occlusal extent of the HRM. On the other hand, the CSI is an SI that will extend peripherally around the outer extent of the HRM. The OSI and CSI can provide for a composite tight seal.

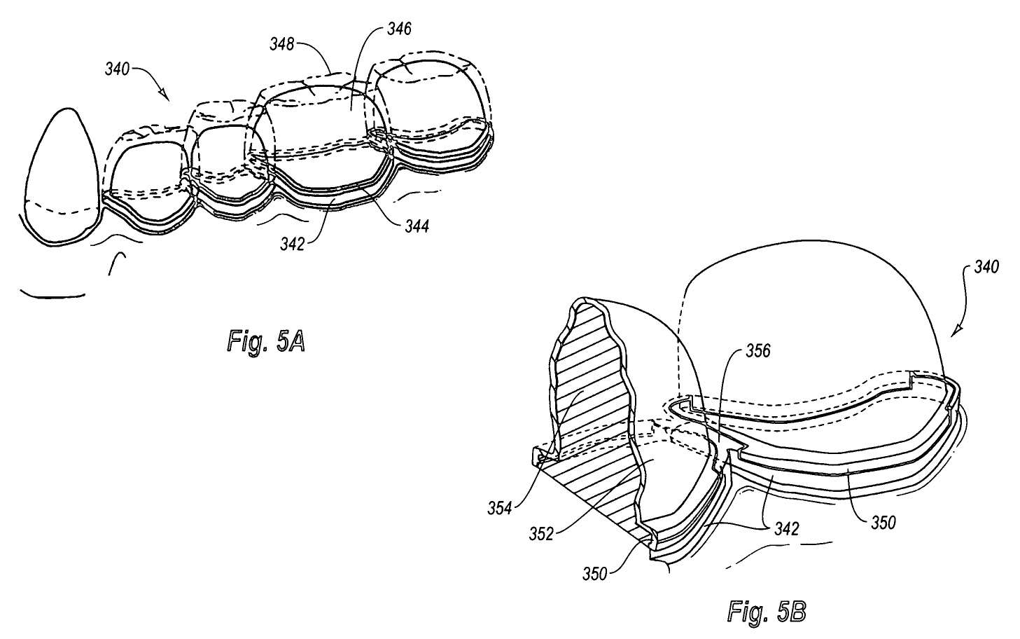

While the restorative matrix system has been described in connection with a single tooth, it can also be used on multiple teeth, and/or full dentitions. As such, FIGS. 5A-5B illustrate an embodiment of a multiple teeth restoration system (“MTRS”) 340, wherein any number or types of teeth can be restored.

Generally, the MTRS 340 is comprised of a multi-tooth HRM 342 configured to fit around the teeth being restored. As before, the multi-tooth HRM 342 includes an SI 344 to receive a single SRM 352 for each tooth 346, or a single SRM for all of the teeth (not shown). Additionally, the multi-tooth HRM 342 includes a spacer region 356 to be positioned between adjacent teeth being restored. The spacer region 356 can allow for separate SRMs 352 to be used on adjacent teeth, or prove a space so that a single SRM can be used for adjacent teeth. The spacer region 356 can also provide natural and/or optimal spacing between adjacent teeth.

The SRM 352 also includes a mold cavity 354 in its interior and a clasp 350 on the front and back of the SRM 352. This configuration allows for the clasp 350 to be coupled with the HRM 342 at the distal or buccal side of the tooth 346 as well as at the back or lingual side. Also, the SRM 352 does not include a clasp at the spacer region 356 between adjacent teeth; however, the restorative system could be configured so that the SRM 352 includes the clasp 350 around the entire tooth, or at any discrete location relative to the HRM 342. Additionally, various other modifications can be made in accordance with the present invention.

The SRMs and HRMs can be fabricated from a wide range of materials. This includes rubbers, plastics, composites, ceramics, metals, and the like, which can be configured to provide the functionalities described herein. Depending on the type of composite material used to build the layers, it can be beneficial to have an SRM comprised of a transparent, translucent, or opaque material. Also, in some embodiments it can be favorable for the SRMs and HRMs to be fabricated from like materials or different materials, which depends on various applications. For example, in some instances it can be preferable for the SRM to be prepared from a flexible material that can fit onto a harder HRM, or vise versa. Also, it can be favorable for both the SRMs and HRMs to be prepared from flexible and/or stretchable materials. This can allow for the HRM to be slightly smaller in diameter and stretch around the teeth being restored so that it forms a snug fit, and the SRM to easily snap onto the HRM.

III. Preparing Dental Restorations

Virtual restorations, which are prepared as described above, can be used as templates or blueprints for making dental restorations. The virtual restoration, which includes the virtual impression, sequential layers, and anatomical layer, can be prepared in situ on the patient's teeth or ex situ via a rapid-manufacturing process and then installed. Thus, the methods of preparing dental restorations are discussed in detail below.

Prior to performing a dental restoration, various well known dental techniques can be employed. Such dental techniques include the following: (a) cleaning the teeth; (b) etching the teeth; (c) bonding the teeth; (d) sealing the teeth; (e) performing root canals; (f) performing extractions; and (g) other appropriate dental procedures. Supplemental information can be found in the incorporated reference.

A. Temporary Orthotic Matrix

In one embodiment of the present invention, a temporary orthotic matrix (“TOM”) for a single tooth through a full dentition may be needed prior to a permanent restoration. In part, the TOM can establish the ideal occlusion as defined by an electromyographic machine. This can allow for the jaw to be in the proper CR or NM rest position on the rest trajectory as verified by computer or bimanual manipulation of the temporomandular joint (“TMJ”). Also, the TOM can aid in reorienting the patent's jaw so that the permanent dental restoration is not prematurely worn-out.

The TOM is fabricated using the virtual restoration with a rapid-manufacturing technique, as described in more detail below. The TOM is filled with an appropriate material, such as a curable or composite material, and installed on the teeth needing restoration. The TOM is positioned and affixed by curing the material. After wearing the TOM for some time, the patient can be ready to receive a permanent restoration as described below. Thus, the TOM is removed and the teeth are prepared for the permanent dental restoration.

B. Restorative Matrix System

In one embodiment of the present invention, the HRM and/or SRMs are fabricated to include mold cavities that are substantially similar with the virtual/restorative layers illustrated and described in connection with FIGS. 2A-B. The method of fabricating restorative matrices can include any rapid-manufacturing technique (rapid-prototyping technique) that uses computer generated three-dimensional images to control the manufacturing process. These rapid-manufacturing techniques include, but are not limited to, stereolithography, selective-laser sintering, fused-deposition modeling, solid ground curing, three-dimensional ink-jet printing, laser shaping, and the like, which are a building-up or additive process. Additionally, other rapid-manufacturing techniques that remove materials from a starting block can be used and include drilling, milling, machining, and other destructive-like fabrication processes.

Accordingly, a method for manufacturing a restorative matrix system can include acquiring a virtual image of the target restoration. As such, the virtual restoration, which includes the tooth/template, sequential layers, and anatomical layer (as in FIG. 2A-B) can be used as a blueprint for preparing each component in the restorative matrix system. The virtual restoration is then processed through a computer system to generate the virtual shapes of the hemostatic restorative matrix (“HRM”), sequential restorative molds (“SRM”), and/or anatomical restorative mold (“ARM”). Also, the ARM can be considered to be an SRM with anatomical features. For the sake of brevity, the sequential SRMs and ARM are manufactured to produce the restorative layers described in connection to FIGS. 2A-B, which can be reviewed for details pertaining to the SRMs and corresponding mold cavities. The HRM, SRMs, and/or ARM can be employed in a process for in situ fabrication of a restoration on a patient's tooth or dentition.

The dental restoration process is initiated by positioning the HRM onto the tooth, where an optional retraction cord can be placed at the gingival extent of the sulcus. Optionally, the HRM is secured using guide buttons, wherein information on using guide buttons can be obtained in the incorporated reference. Also, a hemostatic agent can be applied to gingiva before or after the HRM is installed. Additionally, a rubber dam can be used with the HRM or incorporated therewith, or other dental isolation techniques can be employed.

The HRM is open at the surface and allows direct placement of etching, bonding, sealing, and/or composite materials in an isolated area, which can include up to the entire dentition surrounded by the HRM. As such, a fill line can be incorporated into the HRM to help the dentist know when enough material has been placed therein.

After the HRM is positioned, the SRM can be applied onto the tooth or dentition so as to contact the HRM. For example, the SRM can be provided as follows: (a) loaded with a measured volume of a curable material; (b) loaded with a measured volume of partially polymerized composite; and (c) unloaded, wherein the dental professional can supply the desired type and/or amount of curable material. The curable material can be loaded into the mold by the dental professional before placement onto the tooth, or after the mold is applied to the tooth by being injected through a hole (e.g., air vent) in the mold. Alternatively, the curable material can be placed onto the tooth or dentition before application of the mold. Also, excess quantities of curable materials can be used.

The curable material is characterized by having a curable resin component. Also, the materials forming each layer can include a curable composite, porcelain, ceramic, or other like material. Optionally, a polymerization inducer can be included that produces free radicals when exposed to light, a chemical curing agent, and/or heat. For example, when a light-inducer is used, it is beneficial for the SRMs to be translucent, or even transparent. Also, it can be beneficial for the SRMs to filter white light to specific wavelengths. Moreover, the curable and/or composite materials can include colorants to impart a natural tooth color to the dental restoration, especially when used for more external layers. As such, the curable composite material can be selected based on the following: (a) thickness of layer; (b) color of layer; (c) translucency of layer; (d) opacity of layer; (e) position of layer relative to the tooth; (f) position of layer relative to the first restorative layer, sequential restorative layer, and/or anatomical restorative layer; (g) duration of curing; (h) type of curing; (i) physical characteristics of layer; (j) porosity of layer; (k) hardness of layer (l); and/or (m) flexibility of layer.

The SRM can be installed so that it engages the seating index of the HRM. Vent holes in the SRM can allow air to escape to insure that no bubbles will be incorporated under the layer, and provide a conduit for excess material to escape, which is then removed. While the SRM is in place, the layer is cured. For example, the layer can be cured by free-radical polymerization induced by light, a chemical curing agent, or heat, wherein such polymerizations are well known in the art.

After curing, the SRM is removed and the next SRM in the series is applied using the same technique. It is thought, without being bound thereto, that the layered dental restorations can be prepared within a patient's mouth because the topmost portion of the cured material is not completely cured. The top layer can be considered to be an “inhibition layer” that does not fully cure because of exposure to oxygen. This allows for the material to cross-link or bond with the subsequent layer of curable material. In any event, the ability to cure or bond adjacent layers of materials allows for the preparation of layered dental restorations.

In some instances, the same SRM can be repeatedly used, such as when the polymer shrinks during curing. The number of times a particular SRM is utilized can be determined by the dental professional. Also, when a SRM does not seat, the dental professional can determine the reason for the problem so that it can be corrected. For example, some curable material may need to be removed in the area that causes the SRM to not fit correctly with the HRM, or a new SRM may be needed.

In one embodiment, a thin layer of composite that approximates the layered tooth structure can be applied to the tooth or dentition. Thinner layers can produce a more natural looking restoration. Also, when the SRM is preloaded, a computer program can calculate the thickness of composite to be applied with each SRM.

After the sequential SRMs have been utilized and the corresponding restorative layers have been cured into place (as depicted in FIG. 2A), the final SRM, which is an ARM (ARM 127 in FIG. 2A) can be used to establish the correct anatomical form of the dental restoration. The ARM can be configured to provide the outer layer of restorative material at about 1 mm or less.

In one embodiment, the ARM can be prepared and utilized as described above in connection with the SRMs. Usually, it is loaded with enamel shades of composite and has a mold cavity that forms the grooves, valleys, and other tooth contours (as depicted in FIG. 2B), and finalizes the interproximal contact areas of the restored teeth. After the composite material is cured, the ARM can be removed to reveal a layered dental restoration having desired anatomical features.

In one embodiment, when a single tooth or multiple adjacent restorations are prepared, a portion of the restorations can be constructed of a thin (0.5-1.0 mm) shell of hardened material such as a cured composite or similar to a prefabricated crown. These incisal crown shells can be separately contoured to form proper contact sites without the need of an interproximal membrane. When used, these shells can be inserted into the ARM before installation, which is then loaded with a curable material. The ARM is then installed on the HRM and coupled with the seating index as described above in connection with the SRMs. Optionally, vent holes can be strategically positioned in the ARM and/or incisal crown shell.

In one embodiment, the ARM can be fabricated to accommodate a micron-scale curable layer of about 1-6 microns, and to replicate the interproximal contact areas. Optionally, the ARM can be fabricated of a thin membrane material, which can allow for separation of the teeth at the contact area. After curing the final layer, the excess membrane of the ARM can be flossed out of the contact area or other areas.

In another embodiment, the SRMs and ARM can be configured to be cured onto the tooth as part of the dental restoration. As such, the SRMs and ARM can be prepared from a material that includes some materials still capable of undergoing polymerization or additional cross-linking when exposed to free radicals. That is, the curable material within each mold can be used to cure the mold as part of the restoration. Thus, the molds themselves can be used in preparing the dental restoration.

Additionally, after the dental restoration has been formed, the HRM can be removed by well-known dental techniques that remove materials from teeth. Since the HRM is usually prepared from elastic or flexible materials, it can be removed by making a single cut or multiple cuts. Also, this can include removing the positioning features such as the guide buttons.

After the ARM and/or HRM have been removed, the restoration can be adjusted or shaped by the dental professional using known dental techniques. Also, supplemental information on dental techniques that can be performed along with building the dental restoration in the patient's mouth is in the incorporated reference.

C. Pre-fabricated Layered Dental Restoration

In another embodiment, a layered dental restoration can be prepared outside of the patient's mouth. In this embodiment, a rapid-manufacturing process is used that builds the dental restoration layer-by-layer as described above, and not by a destructive or material removal process. That is, a first layer of material is deposited onto a template or substrate before the subsequent layers are deposited, wherein the deposition process can build an installable restoration as described in connection with FIGS. 2A-B. The sequential layers can be orthogonally deposited relative to the template or substrate as well as the previously deposed layers. As such, the sequential layers are configured to build the dental restoration (e.g., crowns) so that the individual layers can contribute to the desired overall physical and visual characterizes. Generally, the deposited layers provide a desired finished restoration surface visually similar to a natural tooth surface, so that the outer layers are of lighter color and lesser opacity than inner layers.

In one embodiment, the dental restoration is prepared with an ink-jet printing technique by depositing layers of a composite material onto a substrate to build a three-dimensional dental restoration. As such, a layer of powdered composite, such as porcelain, can be deposited onto a substrate before fixing agent, such as an adhesive, is applied onto the powdered composite to form a layer, wherein the powdered composite and/or fixing agent can be ink-jetted. Alternatively, a flowable composite composition that includes a fixing agent can be ink-jetted onto the substrate. In any event, ink-jet printing techniques can be used to form the three-dimensional dental restoration, wherein the use of ink-jetting to produce three-dimensional articles is well known in the art. The materials forming each layer can include a composite, porcelain, ceramic, or other like material.

Additionally, the dental restoration can be hardened by being cured so that it simulates the properties of natural teeth. This can include curing each layer after being deposited, and/or curing the entire dental restoration. As such, each layer can be baked at high temperatures before application of the following layer. Alternatively, the entire dental restoration can be baked in order to harden all of the layers.

In one embodiment, when the dental restoration is being produced by a rapid-manufacturing technology that involves post-production dimensional changes (e.g. shrinking), the size of the restoration can be designed to be adjusted in order to account for such size changes. Thus, both the interior and exterior portions of the finished restoration can be prepared into correct final size, within acceptable tolerances (e.g. ±6 microns).

After the layered dental restoration is pre-fabricated, it can be installed onto a patient's tooth or dentition. As such, the layered dental restoration can be loaded with a curable material so that it bonds with the tooth, which has been properly prepared from receiving such a restoration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for preparing a layered dental restoration, the method comprising:
obtaining a virtual impression of at least one tooth in a dentition;
obtaining a virtual restoration, the virtual restoration being comprised of sequential virtual layers extending from the virtual impression to a virtual restoration exterior surface; and
fabricating a dental restoration from the virtual restoration by sequentially building individual layers of materials to a shape substantially similar with the shape of the virtual restoration exterior surface, wherein each layer corresponds to a virtual layer.

2. A method as in claim 1, wherein creating the virtual impression includes at least one of the following:
forming a negative impression of the at least one tooth;
forming a positive cast in substantially the shape of the at least one tooth;
obtaining at least one digital image of the at least one tooth;
obtaining a virtual three-dimensional image by directly scanning the at least one tooth; or
obtaining a virtual three-dimensional image by scanning a negative impression or positive cast of the at least one tooth.

3. A method as in claim 1, wherein generating the virtual restoration is comprised of:
selecting a shape for the dental restoration, wherein virtual restoration is substantially shaped as the selected dental restoration shape; and
generating the sequential virtual layers between the virtual impression and virtual restoration exterior surface so that sequential restorative layers substantially shaped as the sequential virtual layers can be prepared during fabricating the dental restoration.

4. A method as in claim 3, wherein generating the virtual restoration includes at least one of the following:
calculating a thickness of each virtual layer;
calculating at least one of an internal surface area or external surface area of each virtual layer, wherein the internal surface area of each virtual layer is larger than the external surface area of the preceding layer;
processing the virtual impression and selected dental restoration shape through an algorithm to generate the sequential virtual layers; and
configuring the virtual restoration to have optimal spacing with adjacent teeth.

5. A method as in claim 1, wherein fabricating the dental restoration includes at least one of the following:
depositing a first restorative layer;
optionally, depositing at least one sequential restorative layer on the first restorative layer; and
depositing an anatomical layer on at least one of the first restorative layer or the sequential restorative layer.

6. A method as in claim 5, wherein the first restorative layer is cured prior to depositing the at least one sequential restorative layer or anatomical layer, which is subsequently cured.

7. A method as in claim 5, wherein a material of at least one of the first restorative layer, sequential restorative layer, or anatomical restorative layer is selected based on at least one of the following:
thickness of layer;
color of layer;
translucency of layer;
opacity of layer;
position of layer relative to the at least one tooth;
position of layer relative to the first restorative layer, sequential restorative layer, or anatomical restorative layer;
duration of curing;
type of curing;
physical characteristics of layer;
porosity of layer;
hardness of layer; or
flexibility of layer.

8. A method as in claim 6, wherein fabricating the layered dental restoration further comprises:
obtaining a mold for at least one of the first restorative layer, sequential restorative layer, or anatomical layer;
applying a curable composite material to the at least one tooth, the curable composite material including a curable resin;
placing the mold onto the at least one tooth to shape the curable composite material, wherein placing the mold is performed on a tooth having the curable composite material applied thereto or to apply the curable composite material contained within a mold cavity in the mold to the at least one tooth;
curing the composite material; and
removing the mold.

9. A method as in claim 6, wherein fabricating the dental restoration further comprises:
building the dental restoration layer-by-layer from a first layer configured to contact the at least one tooth when affixed thereto; and
affixing the layered dental restoration to the at least one tooth so that the first layer contacts the at least one tooth.

10. A method of fabricating a dental restoration in a patient's mouth, the method comprising:
placing a hemostatic restorative matrix over at least one tooth of a dentition so as to move gingiva from the at least one tooth, the hemostatic matrix including a seating index;
placing a restorative mold onto the at least one tooth until it seats in the seating index to shape the curable composite material, wherein placing the restorative mold is performed on a tooth having a curable composite material applied thereto or to apply a curable composite material contained within a mold cavity in the mold to the at least one tooth;
curing the curable composite material into a restorative layer; and
removing the restorative mold and hemostatic matrix from the at least one tooth so that the at least one tooth includes at least one restorative layer.

11. A method as in claim 10, further comprising:
placing a second restorative mold in a sequence of restorative molds over the at least one cured restorative layer until it seats in the seating index so as to shape a second curable composite material between the mold to the at least one tooth;
curing the second curable composite material into a second restorative layer;
removing the second restorative mold from the at least one tooth so that the at least one tooth includes at least two cured restorative layers.

12. A method as in claim 11, further comprising:
etching the at least one tooth; and/or
applying a bonding composition to the at least one tooth before contacting the curable resin to the at least one tooth.

13. A method as in claim 12, further comprising:
forming guide buttons on the at least one tooth, the guide buttons configured to orient the hemostatic restorative matrix by triangulation; and
coupling the hemostatic restorative matrix with the guide buttons.

14. A method as in claim 13, further comprising at least one of the following:
preparing the at least one tooth so as to be shaped to receive the hemostatic restorative matrix and the at least one restorative mold;
preparing the at least one tooth so as to have less than or about the same dimension at a top portion as a bottom portion;
applying a retraction cord to the tooth;
configuring the dental restoration to have optimal spacing with adjacent teeth;
removing excess curable composite material from the at least one mold;
removing excess curable composite material that has been passed through an air vent;
applying a rubber dam to the at least one tooth;
removing the guide buttons; or
shaping the layered dental restoration.

15. A method as in claim 11, wherein the hemostatic restorative matrix and series of restorative molds are prepared by the following:
obtaining a virtual impression of the at least one tooth;
obtaining a shape for the dental restoration;
generating sequential virtual layers between the virtual impression and a virtual restoration exterior surface; and
generating a virtual restoration having the virtual restoration exterior surface and being comprised of the sequential virtual layers.

16. A method of fabricating a layered dental restoration, the method comprising:
obtaining a virtual restoration comprised of sequential virtual layers that encompass a virtual impression of at least one tooth in a dentition; and
depositing sequential layers from an interior layer substantially shaped so as to conform with the at least one tooth through an external layer substantially shaped as virtual restoration to form a layered dental restoration, the sequential layers being shaped substantially as the sequential virtual layers.

17. A method as in claim 15, further comprising:
depositing the interior layer onto a removable template substantially shaped as the at least one tooth;
depositing a subsequent layer of the sequential layers onto the interior layer; and
removing the layered dental restoration from the template.

18. A method as in claim 16, wherein the depositing is performed by a rapid-manufacturing technique.

19. A method as in claim 18, wherein the rapid-manufacturing technique is selected from the group comprised of:
stereolithography;
selective-laser sintering;
fused-deposition modeling;
solid-ground curing; and
three-dimensional ink-jet printing.

20. A method as in claim 18, further comprising:
obtaining a virtual impression of the at least one tooth; and
selecting a shape for the layered dental restoration, wherein virtual restoration is substantially shaped as the selected dental restoration shape.

21. A method as in claim 18, further comprising at least one of the following:
preparing the at least one tooth to receive the layered dental restoration;
shaping the at least one tooth to receive the layered dental restoration;
shaping the at least one tooth prior to acquiring the virtual impression;
configuring the dental restoration to have optimal spacing with adjacent teeth;
etching the at least one tooth;
affixing the layered dental restoration to the at least one tooth;
hardening the interior layer to form the hardened interior layer;
hardening the subsequent layer to form a hardened subsequent layer; or
backing the layered dental restoration.

22. A restorative matrix system for use in building a dental restoration within a patient's mouth, the system comprising:
a base member having an aperture defined by an aperture wall, the aperture being configured to fit tightly around at least one tooth, the base member having a seating index external to the aperture wall, the seating index extending at least partially around the base member; and
at least one mold having a mold cavity capable of fitting over the at least one tooth so as to apply a layer of curable material thereto, the at least one mold having a portion configured to releasable seat into the seating index of the base member.

23. A system as in claim 22, further comprising a plurality of molds, wherein the plurality of molds includes sequential molds configured so provide sequential layers of curable materials to the at least one tooth.

24. A system as in claim 23, wherein a last mold of the sequential molds includes a mold cavity configured to provide an outer layer having anatomical features.

25. A system as in claim 24, wherein the system is characterized by at least one of the following:
the base member is a hemostatic restorative matrix;
having at least two separate seating indexes on the base member and at least two separate interlocking portions on the at least one mold, wherein the seating indexes are configured to couple with the interlocking portions;
the base member further comprises a retraction cord;
the last mold is an anatomical restorative matrix;
the at least one mold includes a tab on a peripheral wall;
a portion of the base member includes a clasp;
a portion of the base member includes a retaining groove;
the base member includes a gingival surface configured to push gingiva from the at least one tooth;
the base member includes at least one guide button notch;
the base member includes at least three guide button notches oriented such that the base member can be positioned using triangulation; and
the base member and the at least one mold form a composite-tight seal when coupled, wherein the curable material is a composite.
